(19) United States
(12) Patent Application Publication
(10) Pub. No.: US 2023/0419189 A1
(43) Pub. Date: Dec. 28, 2023

(54) PROGRAMMATIC SELECTOR FOR CHOOSING A WELL-SUITED STACKED MACHINE LEARNING ENSEMBLE PIPELINE AND HYPERPARAMETER VALUES

(71) Applicant: Capital One Services, LLC, McLean, VA (US)

(72) Inventors: Michael LANGFORD, Plano, TX (US); Jakub KRZEPTOWSKI-MUCHA, Lemont, IL (US); Krishna BALAM, Henrico, VA (US)

(73) Assignee: Capital One Services, LLC, McLean, VA (US)

(21) Appl. No.: 17/848,728

(22) Filed: Jun. 24, 2022

(51) Int. Cl. G06N 20/20

(52) U.S. Cl. CPC G06N 20/20

(57) ABSTRACT

The exemplary embodiments may provide a stacked machine learning model ensemble pipeline architecture selector that selects a well-suited stacked machine learning model ensemble pipeline architecture for a specified configuration input and a target data set. The stacked machine learning model ensemble pipeline architecture selector may generate and score possible stacked machine learning model ensemble pipeline architectures to locate one that is well-suited for the target data set and the conforms with the configuration input. The stacked machine learning model ensemble pipeline architecture selector may use genetic programming to generate successive generations of possible stacked ensemble pipeline architectures and to score those architectures to determine how well-suited they are. In this manner, the stacked machine learning model ensemble pipeline architecture selector may converge on an architecture that is well-suited, for example, that meet one or more scores, evaluation metrics, and/or the like.

### BACKGROUND

Machine learning is a type of artificial intelligence that allows software to become more accurate at predicting outcomes without being explicitly programmed to do so. Machine learning algorithms run on data to create machine learning models. Examples of machine learning algorithms include linear regression algorithms, logistic regression algorithms, decision tree algorithms, k-nearest neighbors algorithms and artificial neural networks. A machine learning model is the product of training a machine learning algorithm with training data. The machine learning model captures the rules, number and/or data structures required to make predictions. Machine learning models are essentially trained with algorithms. Machine learning models are generated when the algorithms are applied to a specific data set.

### SUMMARY

In accordance with an inventive aspect, a non-transitory computer-readable storage medium is provided for storing instructions that when executed by a processor cause the processor to: generate a generation of stacked machine learning model ensemble pipeline architectures, wherein each of generated stacked machine learning model ensemble pipeline architectures specifies how many layers of machine learning models there are in the architecture, what machine learning models are on each of the layers and what hyperparameter values are specified for the machine learning models; apply the generation of stacked machine learning model ensemble pipeline architectures to a data set; score how well the stacked machine learning model ensemble pipeline architectures in the generation process the data set; repeat at least once: (1) based on the scores of the stacked machine learning model ensemble pipeline architectures in a most recent generation, select a subset of the stacked machine learning ensemble model pipeline architectures in the previous generation and mutating the stacked machine learning model ensemble pipeline architectures in the previous generation as part of generating a next generation of stacked machine learning model ensemble pipeline architectures, and (2) score how well the next generation of stacked machine learning model ensemble pipeline architectures process the data set, and (3) based on the scores for the next generation of stacked machine learning model ensemble pipeline architectures, determine whether to: repeat steps (1)-(3) with the next generation being the most recent generation, or select one of stacked machine learning model ensemble pipeline architectures in the next generation that meets an evaluation metric.

In some embodiments, steps (1)-(3) may be repeated responsive to a threshold number, percentage, and/or the like (which may include one) of the stacked machine learning model ensemble pipeline architectures not meeting a score threshold.

The selected one of the stacked machine learning model ensemble pipeline architectures may be a best scoring one of the stacked machine learning model ensemble architectures that were scored. Genetic programming may be used in the mutating of the stacked machine learning model ensemble pipeline architectures in the previous generation to generate the next generation of stacked machine learning model ensemble pipeline architectures. The instructions, when executed, may further cause the processor to provide access to the selected one of the stacked machine learning model ensemble pipeline architectures in the next generation for processing another data set. The mutating of the stacked machine learning model ensemble pipeline architectures in the previous generation to generate a next generation of stacked machine learning model ensemble pipeline architectures may comprise modifying a subset of the stacked machine learning model ensemble pipeline architectures in the previous generation. The subset may include stacked machine learning model ensemble pipeline architectures in the previous generation having scores that exceed a threshold. The mutating of the stacked machine learning model ensemble pipeline architectures in the previous generation to generate the next generation of stacked machine learning model ensemble pipeline architectures may include changing what machine learning models are in a layer of at least one of the stacked machine learning model ensemble pipeline architectures in the previous generation. The mutating of the stacked machine learning model ensemble pipeline architectures in the previous generation to generate the next generation of stacked machine learning model ensemble pipeline architectures may include changing how many layers are in at least one of the stacked machine learning model ensemble pipeline architectures in the previous generation. The mutating of the stacked machine learning model ensemble pipeline architectures in the previous generation to generate the next generation of stacked machine learning model ensemble pipeline architectures may include changing at least one hyperparameter for a machine learning model in at least one of the stacked machine learning model ensemble pipeline architectures in the previous generation.

In accordance with another inventive aspect, a non-transitory computer-readable storage medium is provided for storing instructions that when executed by a processor cause the processor to receive as input an indication of what machine learning models may be used in a stacked machine learning model ensemble pipeline architecture and receive as input an identification of hyperparameters for the machine learning models that may be used in a stacked machine learning model ensemble pipeline architecture. The instructions also cause the processor to, based on the inputs, generate stacked machine learning model pipeline architectures which contain at least two layers, with each layer including multiple ones of the machine learning models that may be used and to generate possible hyperparameter values for the generated stacked machine learning model pipeline architectures. The instructions further cause the processor to score the generated stacked machine learning model pipeline architectures based on a performance with the generated possible hyperparameter values in processing a data set and to select one of the generated stacked machine learning model pipeline architectures and a set of generated possible hyperparameter values based on a score associated with each of the generated stacked machine learning model pipeline architectures.

The instructions may include instructions that when executed by a processor cause the processor to receive as input value ranges for the hyperparameters. The generating of the stacked machine learning model pipeline architectures which contain at least two layers may include generating an object instance for each generated stacked machine learning model pipeline architecture. Each object instance for each generated stacked machine learning model pipeline architecture may include methods for the machine learning models in each of the generated stacked machine learning model pipeline architectures. Each object instance for each generated stacked machine learning model pipeline architecture may include generated hyperparameter values for the machine learning models in each of the generated stacked machine learning model pipeline architectures. The generating of the stacked machine learning model pipeline architectures may entail using genetic programming to generate generations of the stacked machine learning model pipeline architectures. The selecting of the selected one of the generated stacked machine learning model pipeline architectures and a set of generated possible hyperparameter values as best performing may include selecting an optimal generated stacked machine learning model pipeline architecture with an optimal set of hyperparameter values.

In accordance with an additional inventive aspect, a method is performed by a processor of a computing device. The method includes generating with the processor stacked machine learning model pipeline architectures which contain at least two layers, with each layer including multiple ones of the machine learning models that may be used and generating with the processor possible hyperparameter values for the generated stacked machine learning model pipeline architectures. The method further includes scoring the generated stacked machine learning model pipeline architectures based on a performance with the generated possible hyperparameter values in processing a data set and selecting one of the generated stacked machine learning model pipeline architectures and a set of generated possible hyperparameter values based on a score associated with each of the generated stacked machine learning model pipeline architectures.

The generating with the processor of the stacked machine learning model pipeline architectures which contain at least two layers may be based on configuration input that specifies what machine learning models may be used in the stacked machine learning model ensemble pipeline architecture. The generating with the processor of possible hyperparameter values for the generated stacked machine learning model pipeline architectures may be based on configuration information that specifies possible value ranges of the hyperparameters. The generating with the processor of the stacked machine learning model pipeline architectures which contain at least two layers may include applying a mutation operation to a previous generation of stacked machine learning model pipeline architectures with at least two layers to generate another generation of stacked machine learning model pipeline architectures with at least two layers.

### BRIEF DESCRIPTION OF THE DRAWINGS

FIG. 1 depicts an illustrative machine learning model ensemble that is suitable for exemplary embodiments.

FIG. 2 depicts an illustrative stacked machine learning model ensemble that is suitable for exemplary embodiments.

FIG. 3 depicts a block diagram showing use of a stacked machine learning model ensemble pipeline architecture selector that is suitable for exemplary embodiments.

FIG. 4 depicts a flowchart of illustrative steps that may be performed in exemplary embodiments in selected a well-suited pipeline architecture.

FIG. 5 depicts a flowchart of illustrative steps that may be performed in exemplary embodiments in applying genetic programming in the selection process.

FIG. 6 depicts a flowchart of illustrative steps that may be performed in generating a next generation of pipeline architectures in an exemplary embodiment.

FIG. 7 depicts an example of a crossover operation performed on pipeline architectures in an exemplary embodiment.

FIG. 8 depicts an example of a mutation operation performed on pipeline architectures in an exemplary embodiment.

FIG. 9A depicts an exemplary pipeline architecture object.

FIG. 9B depicts an exemplary layer object.

FIG. 9C depicts an exemplary model object.

FIG. 10 depicts an illustrative computing environment that is suitable for practicing exemplary embodiments.

### DETAILED DESCRIPTION

Machine learning models may have associated hyperparameters. Hyperparameters are parameters that define the model architecture. For example, for a decision tree model, a hyperparameter may specify the maximum depth allowed for a decision tree. As another example, for a random forest model, a hyperparameter may specify how many trees are included in the model.

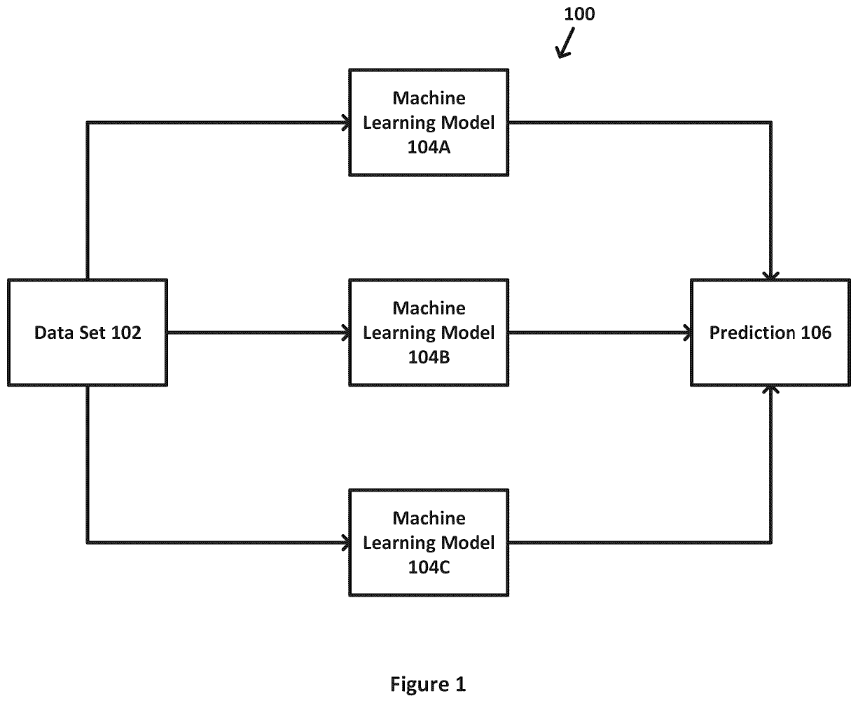

Because a single machine learning model may not be well-suited for making predictions for a data set, machine learning ensembles that include multiple machine learning models have been developed. FIG. 1 depicts an example of a machine learning model ensemble 100. The machine learning model ensemble 100 receives a data set 102 as input that is to be processed by the machine learning model ensemble 100. The machine learning model ensemble 100 includes three machine learning models 104A, 104B and 104C. Each machine learning model 104A, 104B and 104C processes the data set to make a prediction that is used in making the ensemble prediction 106. Each machine learning model 104A, 104B and 104C may have been trained using a unique machine learning algorithm.

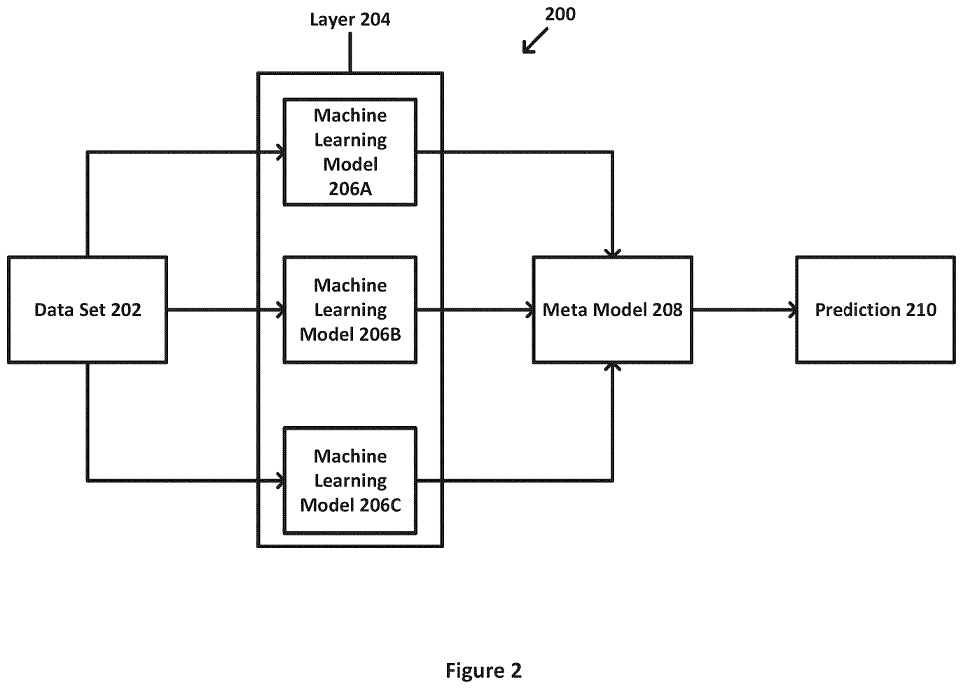

With stacked machine learning model ensembles, the ensembles have multiple layers rather than a single layer. A layer may refers to a set of machine learning models (typically greater than one model). FIG. 2 depicts an example stacked machine learning model ensemble 200. The stacked machine learning model ensemble 200 includes a layer 204 that includes multiple machine learning models 206A, 206B and 206C. The machine learning models 206A, 206B and 206C each receive data set 202 as input and generate outputs based on processing of the inputs. The stacked machine learning model ensemble 200 also includes a second layer in the form of meta model 208. The meta model 208 accepts the outputs (e.g., predictions) of the machine learning models 206A, 206B and 206C as inputs and generates its own output in the form of prediction 210. The meta model 208 is trained to make accurate predictions based on the outputs of the machine learning models 206A, 206B and 206C. In other instances, a stacked machine learning model ensemble may include additional layers, such as having three layers in total.

It is very challenging for a developer to choose what pipeline architecture to choose for a stacked machine learning model ensemble. The pipeline architecture must specify how many layers to use, what machine learning models are to be included in each layer and what hyperparameter values are to be used. A developer may often just make a best guess and apply a trial-and-error approach to choosing the pipeline architecture. The process of choosing the pipeline architecture tends to be very time consuming and often results in pipeline architectures that are not well-suited for processing the data set of interest.

The exemplary embodiments may provide a stacked machine learning model ensemble pipeline architecture selector that selects a well-suited stacked machine learning model ensemble pipeline architecture for a specified configuration input and a target data set. Optimized or “well-suited”in one non-limiting context may refer to an ensemble which meets or performs well with a user's evaluation metric. One example of an evaluation metric may include a holdout dataset. Other evaluation metrics may include data format (e.g., working with a particular type of data or data format), performance metrics (e.g., resource usage, time to get a result), accuracy, error rate (e.g., mean absolute error, mean squared error), false positives below threshold, false negatives below a threshold, logarithmic loss, confusion matrix, area under curve (AUC), F1 score, precision, recall, hyperparameter performance (an evaluation of how the hyperparameters work with the pipeline architecture), and/or the like. Well-suited may refer to various other metrics, characteristics, properties, and/or the like of an ensemble. In some embodiments, well-suited may include an evaluation metric meeting a threshold performance value. In one non-limiting example, well-suited for a particular pipeline architecture may include a pipeline architecture that works with data type X (e.g., image files) that has an error rate below Y %. In another non-limiting example, well-suited for a pipeline architecture may include a pipeline architecture configured to provide result X (e.g., determine objects in images) with a resource utilization below Y % (e.g., memory and/or processor requirements). Embodiments are not limited in this context.

The stacked machine learning model ensemble pipeline architecture selector may generate and score possible stacked machine learning model ensemble pipeline architectures to locate one that is well-suited for the target data set and that conforms with the configuration input. The stacked machine learning model ensemble pipeline architecture selector may use genetic programming to generate successive generations of possible stacked ensemble pipeline architectures and to score those architectures to determine how well-suited they are. In this manner, the stacked machine learning model ensemble pipeline architecture selector converges on an architecture that is optimized or otherwise well-suited.

As part of selecting the pipeline architecture, the stacked machine learning model ensemble pipeline architecture selector also selects hyperparameter values. Thus, the result of the processing by the stacked machine learning model ensemble pipeline architecture selector is a stacked machine learning model ensemble pipeline architecture that is well-suited and that includes well-suited hyperparameter values. In some exemplary embodiments, the stacked machine learning model ensemble pipeline architecture selector may select an optimal stacked machine learning model ensemble pipeline architecture with optimal hyperparameter values. Moreover, the selector is able to select the well-suited stacked machine learning model ensemble pipeline architecture in a much shorter period of time than if a developer attempted to manually select a well-suited stacked machine learning model ensemble pipeline architecture with well-suited hyperparameter values. In addition, the selector may work with more than two layers in a stacked machine learning model ensemble pipeline architecture.

The selected stacked machine learning model ensemble pipeline architecture specifies details of a processing pipeline for a stacked machine learning model ensemble. The selected stacked machine learning model ensemble pipeline architecture may specify how many layers are in the stacked machine learning model ensemble pipeline architecture, how the layers are connected, what machine learning models are contained in each layer and hyperparameter values. When the stacked machine learning model ensemble pipeline architecture is selected, a notification of the selection may be generated and output to a user. Moreover, the selected stacked machine learning model ensemble pipeline architecture may be made available for use by the user to process a data set.

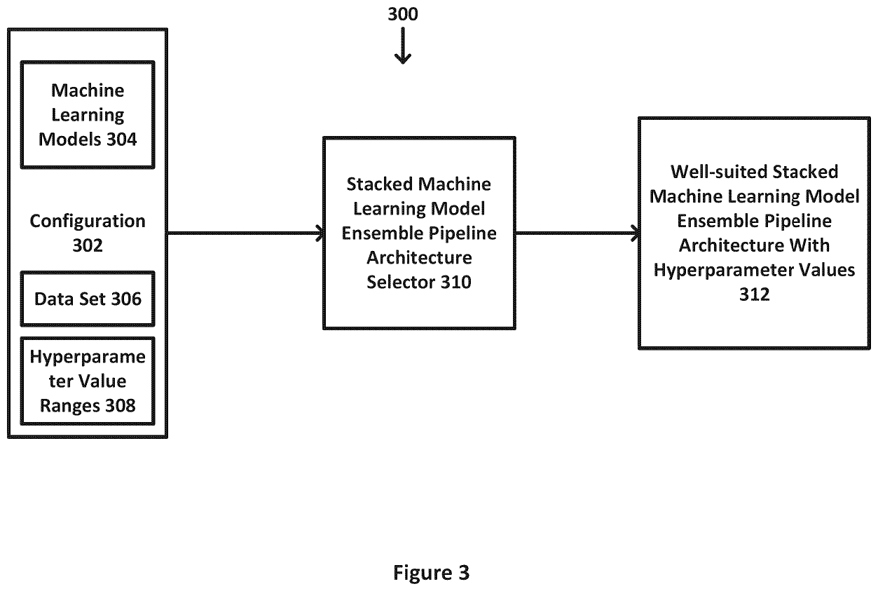

As shown in FIG. 3, in exemplary embodiments, a configuration 302 may be provided to a stacked machine learning model ensemble pipeline architecture selector (hereinafter “selector”) 310. The selector 310 includes one or more programs, libraries, modules or the like for performing the processing for selecting a well-suited pipeline architecture 312 as will be described in more detail below. The configuration 302 may specify configuration values for a desired stacked machine learning model ensemble pipeline architecture. For instance, the configuration 302 may specify what machine learning models 304 are available for inclusion in the selected machine learning model ensemble pipeline architecture (hereinafter “selected pipeline architecture”). For example, the configuration 302 may specify that decision tree models, random forest models, and k-nearest neighbors models may be used in the selected pipeline architecture. The configuration 302 may specify a data set 306 that the selected pipeline architecture is to receive as input and process. For example, the configuration 302 may specify that images of cars are the data set 306. The configuration 302 may also include a specification of possible ranges for hyperparameter values 308. For example, the hyperparameter for the maximum depth of a decision tree may have a possible range of maximum depths of 3 layers to 10 layers.

The configuration 302 may be specified by configuration information in a file, a record or another type of data structure. The configuration 302 instead may be specified by one or more links or references to where the specified configuration information may be found and accessed. The configuration 302 may be specified by input values that are passed to the selector 310, such as through a user interface, like a graphical user interface (GUI). Other information may also be specified in the configuration 302.

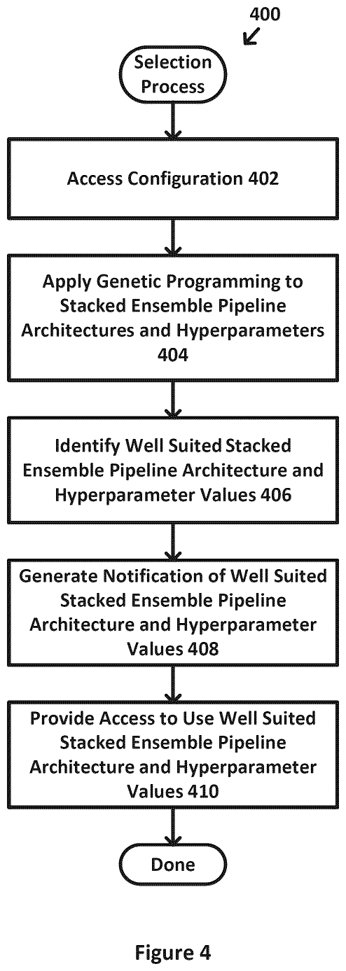

FIG. 4 provides a flowchart 400 of illustrative steps that may be performed by the selector 310 in exemplary embodiments to select a well-suited pipeline architecture. At 402, the configuration 302 may be accessed by the selector 310. As mentioned above, the selector 310 may receive the configuration 302 as input and be given information for accessing the configuration, such as storage location, data format information, configuration information, and/or the like. At 404, the selector 310 may generate and may examine possible pipeline architectures using genetic programming and score those generated pipeline architectures. For example, the selector may use genetic programming to generate successive generations of possible stacked ensemble pipeline architectures that may be scored to determine how well-suited they are. In some embodiments, a score may be associated with at least one evaluation metric, including, without limitation, a holdout dataset, data format, performance metrics, accuracy, error rate, false positives below threshold, false negatives below a threshold, logarithmic loss, confusion matrix, area under curve (AUC), F1 score, precision, recall, hyperparameter performance, and/or the like. In various embodiments, the score may be an indication of whether a pipeline architecture meets one or more evaluation metrics.

At 406, the selector may use the scores to select for the user a well-suited pipeline architecture 312 with well-suited hyperparameter values. As will be described below, the generation and scoring of pipeline architectures may be performed iteratively. In some exemplary embodiments, a genetic programming approach may be employed in which a current generation of pipelines is scored, and the high scoring pipeline architectures are used to spawn a next generation of pipeline architectures. High-scoring may include pipeline architectures above a threshold score, a “top” number of pipeline architectures (e.g., select the top 3 pipeline architectures), and/or the like. This process is repeated until an optimal, near optimal or sufficiently well-suited pipeline architecture with hyperparameter values is generated and selected. Ideally, the iterations converge upon an optimal or near-optimal pipeline architecture.

At 408, the selector 310 may send a notification to the user of the selection of a pipeline architecture. In some exemplary embodiments, no notification is sent. The notification may be an email, a message, a file, a graphic output on a display or the like. The notification may identify the particulars of the selected pipeline architecture. For example, the notification may identify the layers of the selected pipeline and the machine learning models in each layer. The notification may also identify the hyperparameter values.

At 410, the selector may provide the user with access to the selected pipeline architecture so that the user may use the selected pipeline architecture on a data set. For example, the selector may identify the selected pipeline architecture and provide a link, file, message, and/or the like to provide access to the selected pipeline architecture

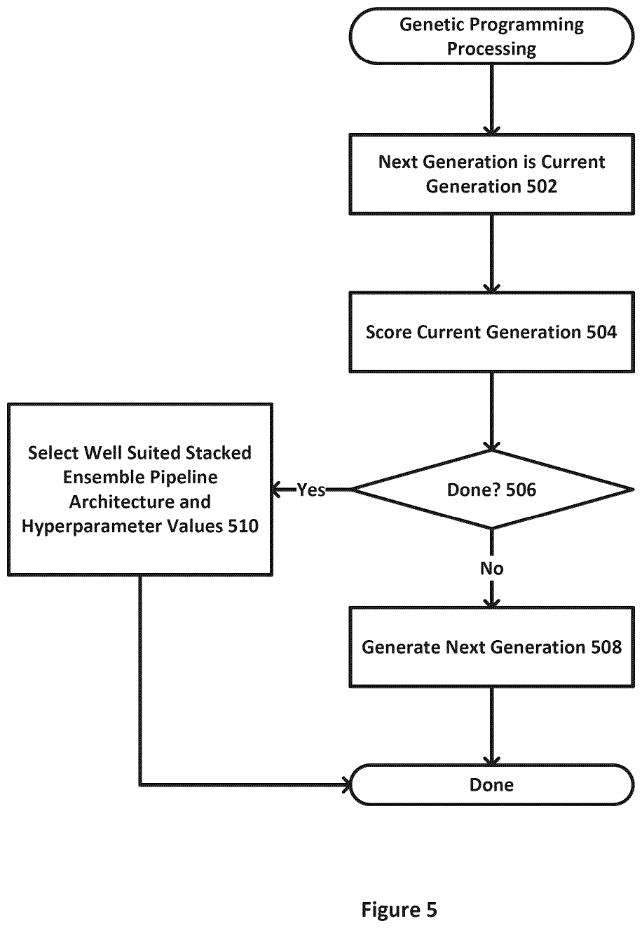

FIG. 5 depicts a flowchart 500 of illustrative more detailed steps that may be performed in applying the genetic programming 404 and identifying the well-suited stacked ensemble pipeline architecture and hyperparameter values 406. At 502, a next generation of pipeline architectures that has been generated is designated as the current generation. As will be described below, the next generation for second and subsequent generations may be generated by genetic programming. In some embodiments, the first generation may be randomly generated. In various embodiments, the first generation may be specified by a user. At 504, the current generation is scored by applying a fitness function. The scoring may be performed by applying the fitness function to each of the pipeline architectures in the current generation. The fitness function may vary, but a suitable fitness function measures how well the pipeline architecture performs on a sample data set. Scoring functions, such as those found in open-source machine learning resources, like scikit-learn, may be used. At 506, once the scoring is performed, a check is made whether the last generation has been scored. For example, a user may specify how many generations are to be generated (e.g., 100). Alternatively, a threshold for a score of a well-suited pipeline architecture may be established and once such a pipeline architecture has been found, the processing may stop.

If the scoring of generations of pipeline architectures is done, the selector 310 selects the well-suited pipeline architecture at 510. This may entail simply selecting the pipeline architecture that has scored the highest across the generations. If, however, the scoring of the generations of pipeline architectures is not done, a next generation may be generated at 508.

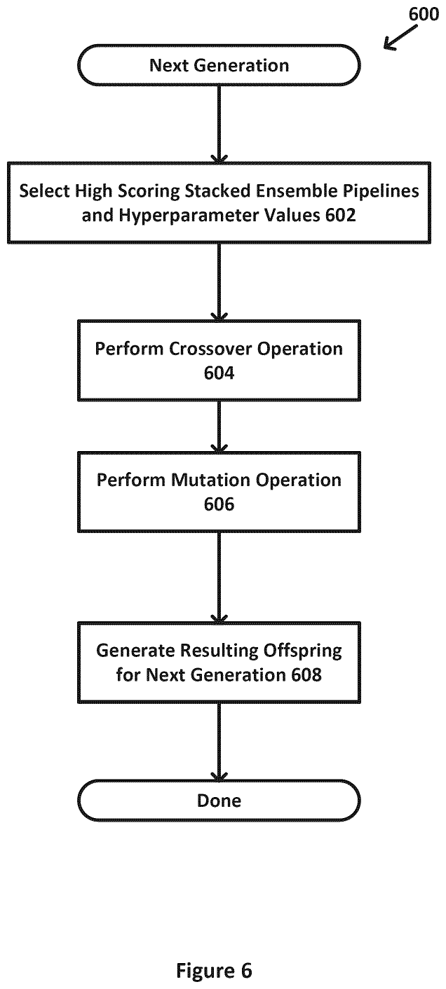

FIG. 6 depicts a flowchart 600 of illustrative steps that may be performed to generate the next generation 508. High scoring pipeline architectures and/or hyperparameters may be selected 602. This may entail, for example, selecting the pipeline architectures in the current generation that score in a top number or percentage (e.g., top 5%, top 10, and/or the like) and/or that score over a threshold value.

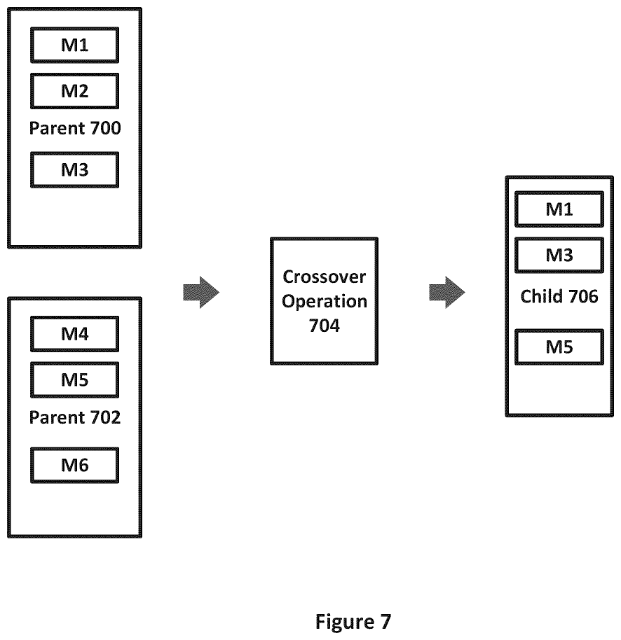

At 604, a crossover operation may be performed on two parent pipeline architectures in the selected group. FIG. 7 depicts an illustrative crossover operation 704. The crossover operation is analogous to that found in nature where desirable characteristics from the respective parents are propagated to the child. In this instance, the example considers the case where a parent pipeline architecture 700 in the top 5% scoring (or other high scoring metric) for the current generation includes models M1, M2, and M3 and the other parent pipeline architecture 702 in the top 5% scoring for the current generation includes models includes models M4, M5 and M6. Given that the models M1, M3 and M5 are desirable, the crossover operation 704 selects those models to be included in the child pipeline architecture 706 of the next generation. The crossover operation 704 may also operate on how many layers are included in the child pipeline architecture, what hyperparameter values are included in the child pipeline architecture, etc.

With reference to FIG. 6 again, at 606, a mutation operation is performed on the child pipeline architecture. The mutation operation constitutes a random change in the child pipeline architecture. It should be appreciated that not each child pipeline architecture needs to be mutated; rather only a subset may be mutated in some instances.

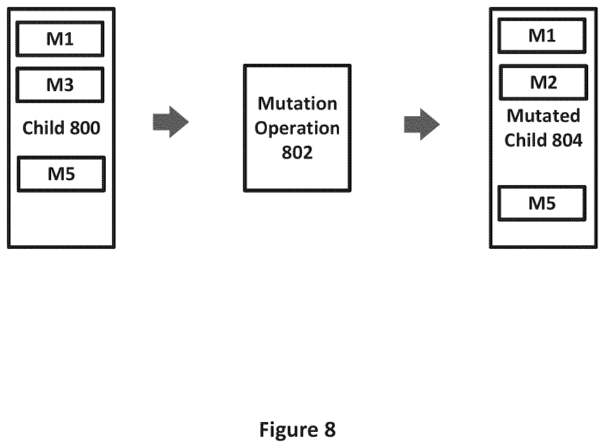

FIG. 8 depicts an example of a mutation operation 802. A child pipeline architecture 800 includes models M1, M3 and M5. The mutation operation 802 modifies the child pipeline architecture 800 to replace model M3 with model M2 to produce mutated child pipeline architecture 804.

The resulting offspring (i.e., child pipeline architectures) are used to form the next generation of pipeline architectures. The entire next generation of pipeline architectures may result from the crossover and mutation operations. In other embodiments, the next generation may also include other randomly generated pipeline architectures.

Object classes and object instances may be created for the pipeline architectures and components of the pipeline architectures. For instance, object classes may be defined for pipeline architectures, layers, machine learning models and hyperparameters. Object instances may be instantiated during the pipeline architecture generation and scoring processes.

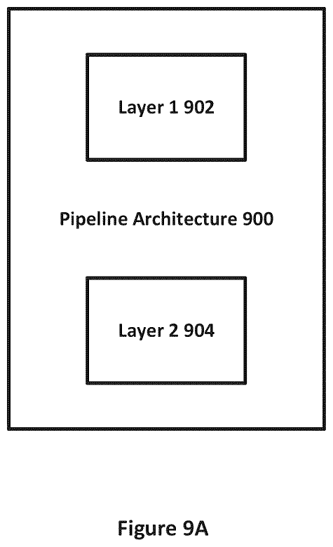

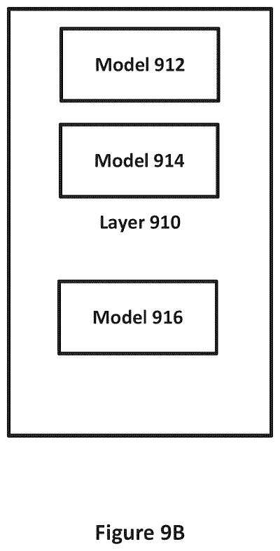

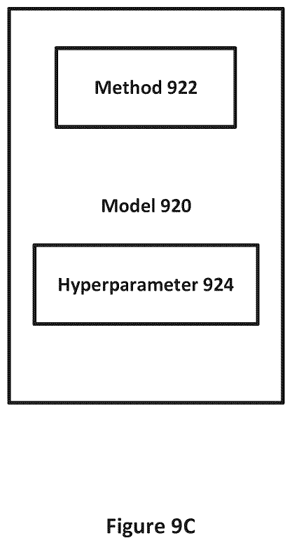

FIG. 9A shows an example of a pipeline architecture object 900. The pipeline architecture object 900 contains methods and data for a pipeline architecture. The pipeline architecture object 900 shown in FIG. 9A, includes layer objects 902 for 904 for layers 1 and 2, respectively. This example assumes that the pipeline architecture associated with pipeline architecture object 900 has two layers. If the associated pipeline architecture had three layers, there would be three layer objects. Each layer object 902 and 904 holds methods and data for a given layer.

FIG. 9B depicts an illustrative layer object 910. The layer object includes learning objects 912, 914 and 916 for the models contained within the layer. The model objects 912, 914 and 916 include methods and data for the associated models.

FIG. 9C depicts an illustrative model object 920. A method object 922 is provided for a method performed by the model 920. A hyperparameter object 924 is also provided for a hyperparameter of the object. In some instance, the hyperparameter object 924 may be included in an associated method. Although only one method object 922 and only one hyperparameter object 924 are shown, it should be appreciated that the model object may include multiple methods and hyperparameters.

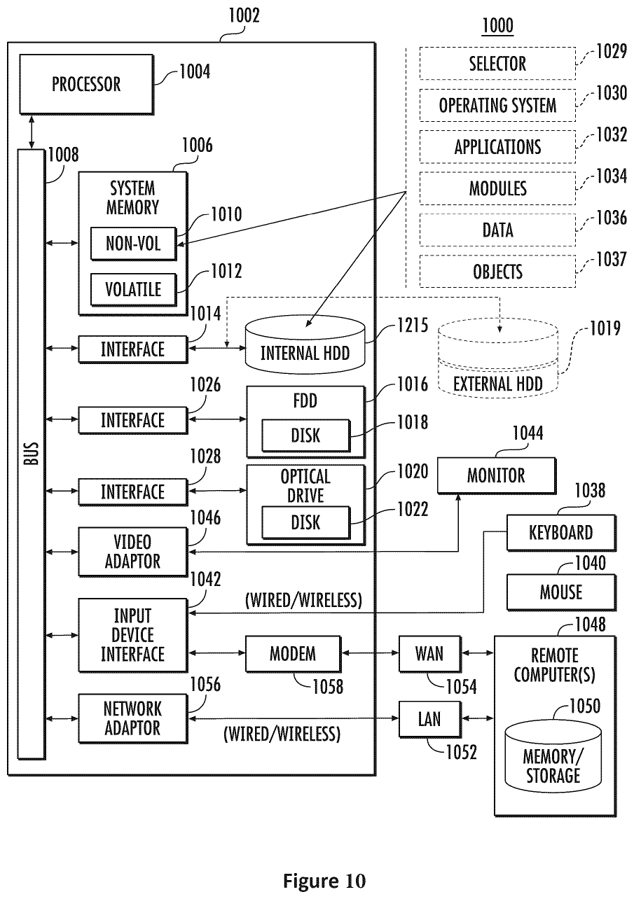

The methods described herein may be performed by a computing environment 1000, such as that depicted in FIG. 10. FIG. 10 illustrates an embodiment of an exemplary computing environment 1000 that includes a computing device 1002 that may be suitable for implementing various embodiments as previously described. In various embodiments, the computing environment 1000 may comprise or be implemented as part of an electronic device. For example, the computing device may be part of a cluster or may be a standalone computer, such as a desktop computer, a serve computer, a laptop computer or the like. More generally, the computing environment 1000 is configured to implement all logic, applications, systems, methods, apparatuses, and functionality described herein with reference to FIGS. 1-9C.

As used in this application, the terms “system” and “component” and “module” may refer to a computer-related entity, either hardware, a combination of hardware and software, software, or software in execution, examples of which are provided by the exemplary computing environment 1000. For example, a component can be, but is not limited to being, a process running on a computer processor, a computer processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing device 1002 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing device 1002.

As shown in FIG. 10, the computing device 1002 includes a processor 1004, a system memory 1006 and a system bus 1008. The processor 1004 can be any of various commercially available computer processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi-processor architectures may also be employed as the processor 1004.

The system bus 1008 provides an interface for system components including, but not limited to, the system memory 1006 to the processor 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computing device 1002 may include various types of computer-readable storage media in the form of one or more lower speed memory units, including an internal (or external) hard disk drive (HDD) 1214, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by an HDD interface 1024, an FDD interface 1026 and an optical drive interface 1028, respectively. The HDD interface 1024 for external drive implementations can include at least one or both of Universal Serial Bus (USB) and IEEE 1394 interface technologies. The computing device 1002 is generally is configured to implement all logic, systems, methods, apparatuses, and functionality described herein with reference to FIGS. 1-9C.

The drives and associated computer-readable media provide volatile and/or nonvolatile storage of data, data structures, computer-executable instructions, and so forth. For example, a number of program modules can be stored in the drives and memory units 1010, 1012, including the selector 1029, an operating system 1030, one or more application programs 1032, other program modules 1034, program data 1036 and the objects 1027 used in the above-described process. In one embodiment, the one or more application programs 1032, other program modules 1034, and program data 1036 can include, for example, the various applications and/or components of the system.

A user can enter commands and information into the computing device 1002 through one or more wire/wireless input devices, for example, a keyboard 1038 and a pointing device, such as a mouse 1040. Other input devices may include microphones, infra-red (IR) remote controls, radio frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processor 1004 through an input device interface 1042 that is coupled to the system bus 1008 but can be connected by other interfaces such as a parallel port, IEEE 1394 serial port, a game port, a USB port, an IR interface, and so forth.

A monitor 1044 or other type of display device is also connected to the system bus 808 via an interface, such as a video adaptor 1046. The monitor 1044 may be internal or external to the computing device 1002. In addition to the monitor 1044, a computer typically includes other peripheral output devices, such as speakers, printers, and so forth.

The computing system 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computing system 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computing device 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computing device 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computing device 1002, or portions thereof, can be stored in the remote memory/storage device 1050. It will be appreciated that the network connections shown are exemplary and other means of establishing a communications link between the computers can be used.

The computing device 1002 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

1. A non-transitory computer-readable storage medium for storing instructions that when executed by a processor cause the processor to:
generate a generation of stacked machine learning model ensemble pipeline architectures, wherein each of generated stacked machine learning model ensemble pipeline architectures specifies how many layers of machine learning models there are in the architecture, what machine learning models are on each of the layers and what hyperparameter values are specified for the machine learning models;
apply the generation of stacked machine learning model ensemble pipeline architectures to a data set;
score how well the stacked machine learning model ensemble pipeline architectures in the generation process the data set; and
repeat at least once:
(1) based on the scores of the stacked machine learning model ensemble pipeline architectures in a most recent generation, select a subset of the stacked machine learning ensemble model pipeline architectures in the previous generation and mutating the stacked machine learning model ensemble pipeline architectures in the previous generation as part of generating a next generation of stacked machine learning model ensemble pipeline architectures, and
(2) score the next generation of stacked machine learning model ensemble pipeline architectures process the data set,
(3) based on the scores for the next generation of stacked machine learning model ensemble pipeline architectures, determine whether to:
repeat steps (1)-(3) with the next generation being the most recent generation, or
select one of stacked machine learning model ensemble pipeline architectures in the next generation that meets an evaluation metric.

2. The non-transitory computer-readable storage medium of claim 1, wherein the selected one of the stacked machine learning model ensemble pipeline architectures is a best scoring one of the stacked machine learning model ensemble architectures that were scored.

3. The non-transitory computer-readable storage medium of claim 1, wherein genetic programming is used in the mutating of the stacked machine learning model ensemble pipeline architectures in the previous generation to generate the next generation of stacked machine learning model ensemble pipeline architectures.

4. The non-transitory computer-readable storage medium of claim 1, wherein the instructions when executed further cause the processor to provide access to the selected one of the stacked machine learning model ensemble pipeline architectures in the next generation for processing another data set.

5. The non-transitory computer-readable storage medium of claim 1, wherein the mutating the stacked machine learning model ensemble pipeline architectures in the previous generation to generate a next generation of stacked machine learning model ensemble pipeline architectures comprises modifying a subset of the stacked machine learning model ensemble pipeline architectures in the previous generation.

6. The non-transitory computer-readable storage medium of claim 5, wherein the subset comprises stacked machine learning model ensemble pipeline architectures in the previous generation having scores that exceed a threshold.

7. The non-transitory computer-readable storage medium of claim 1, wherein the mutating of the stacked machine learning model ensemble pipeline architectures in the previous generation to generate the next generation of stacked machine learning model ensemble pipeline architectures comprises changing what machine learning models are in a layer of at least one of the stacked machine learning model ensemble pipeline architectures in the previous generation.

8. The non-transitory computer-readable storage medium of claim 1, wherein the mutating of the stacked machine learning model ensemble pipeline architectures in the previous generation to generate the next generation of stacked machine learning model ensemble pipeline architectures comprises changing how many layers are in at least one of the stacked machine learning model ensemble pipeline architectures in the previous generation.

9. The non-transitory computer-readable storage medium of claim 1, wherein the mutating of the stacked machine learning model ensemble pipeline architectures in the previous generation to generate the next generation of stacked machine learning model ensemble pipeline architectures comprises changing at least one hyperparameter for a machine learning model in at least one of the stacked machine learning model ensemble pipeline architectures in the previous generation.

10. A non-transitory computer-readable storage medium for storing instructions that when executed by a processor cause the processor to:
receive as input an indication of what machine learning models may be used in a stacked machine learning model ensemble pipeline architecture;
receive as input an identification of hyperparameters for the machine learning models that may be used in a stacked machine learning model ensemble pipeline architecture;
based on the inputs, generate stacked machine learning model pipeline architectures which contain at least two layers, with each layer including multiple ones of the machine learning models that may be used;
generate possible hyperparameter values for the generated stacked machine learning model pipeline architectures;
score the generated stacked machine learning model pipeline architectures based on a performance with the generated possible hyperparameter values in processing a data set; and
select one of the generated stacked machine learning model pipeline architectures and a set of generated possible hyperparameter values based on a score associated with each of the generated stacked machine learning model pipeline architectures.

11. The non-transitory computer-readable storage medium of claim 10, wherein the instructions include instructions that when executed by a processor cause the processor to receive as input value ranges for the hyperparameters.

12. The non-transitory computer-readable storage medium of claim 10, wherein the generating of the stacked machine learning model pipeline architectures which contain at least two layers comprises generating an object instance for each generated stacked machine learning model pipeline architecture.

13. The non-transitory computer-readable storage medium of claim 12, wherein each object instance for each generated stacked machine learning model pipeline architecture includes methods for the machine learning models in each of the generated stacked machine learning model pipeline architectures.

14. The non-transitory computer-readable storage medium of claim 13, wherein each object instance for each generated stacked machine learning model pipeline architecture includes generated hyperparameter values for the machine learning models in each of the generated stacked machine learning model pipeline architectures.

15. The non-transitory computer-readable storage medium of claim 10, wherein the generating of the stacked machine learning model pipeline architectures comprises using genetic programming to generate generations of the stacked machine learning model pipeline architectures.

16. The non-transitory computer-readable storage medium of claim 10, wherein the selecting of the one of the generated stacked machine learning model pipeline architectures and a set of generated possible hyperparameter values as best performing comprises selecting an optimal generated stacked machine learning model pipeline architecture with an optimal set of hyperparameter values.

17. A method performed by a processor of a computing device, comprising, via the processor:
generating stacked machine learning model pipeline architectures which contain at least two layers, with each layer including multiple ones of the machine learning models that may be used;
generating possible hyperparameter values for the generated stacked machine learning model pipeline architectures;
scoring the generated stacked machine learning model pipeline architectures based on a performance with the generated possible hyperparameter values in processing a data set; and
selecting one of the generated stacked machine learning model pipeline architectures and a set of generated possible hyperparameter values based on a score associated with each of the generated stacked machine learning model pipeline architectures.

18. The method of claim 17, wherein the generating of stacked machine learning model pipeline architectures which contain at least two layers is based on configuration input that specifies what machine learning models may be used in the stacked machine learning model ensemble pipeline architecture.

19. The method of claim 17, wherein the generating of possible hyperparameter values for the generated stacked machine learning model pipeline architectures is based on configuration information that specifies possible value ranges of the hyperparameters.

20. The method of claim 17, wherein the generating of the stacked machine learning model pipeline architectures which contain at least two layers comprises applying a mutation operation to a previous generation of stacked machine learning model pipeline architectures with at least two layers to generate another generation of stacked machine learning model pipeline architectures with at least two layers.
